(19) United States
(12) Patent Application Publication
(10) Pub. No.: US 2025/0127590 A1
(43) Pub. Date: Apr. 24, 2025

(54) AUTOMATIC CLEANING DEVICE BASED ON A DECONTAMINATION ROBOT AND AN AUTOMATIC CLEANING METHOD

(71) Applicant: General Hospital of Northern Theater Command of the Chinese People's Liberation Army, Shenyang City (CN)

(72) Inventors: Huishan Wang, Shenyang City (CN); Yu Liu, Shenyang City (CN); Cong Wang, Shenyang City (CN); Tong Liu, Shenyang City (CN)

(73) Assignee: General Hospital of Northern Theater Command of the Chinese People's Liberation Army, Shenyang City (CN)

(21) Appl. No.: 18/991,514

(22) Filed: Dec. 21, 2024

(30) Foreign Application Priority Data
Dec. 21, 2023 (CN) CN202311772732.8

(51) Int. Cl. A61B 90/70; A61B 34/30

(52) U.S. Cl. CPC A61B 90/70; A61B 34/30

(57) ABSTRACT

The present application discloses an automatic cleaning device based on a decontamination robot and an automatic cleaning method, belonging to the field of mechanical automation engineering technology. The device includes a cleaning head, a cleaning seat, a protective housing and a cleaning module; wherein the cleaning head is fixedly mounted in the cleaning seat; the cleaning seat is rotationally connected with the cleaning module, and the cleaning module drives the cleaning seat and the cleaning head to realize up-and-down reciprocating motion. The protective housing passes through the cleaning head and cleaning seat and is fixedly connected with the cleaning module, which can prevent harmful substances caused by cleaning from entering the inner cavity of the cleaning module and causing damage to the mechanism.

### TECHNICAL FIELD

The application relates to the technical field of mechanical automation engineering technology, in particular to an automatic cleaning device based on a decontamination robot and an automatic cleaning method.

### BACKGROUND

In the current international situation, mankind is faced with various forms of nuclear, biological, and chemistry (NBC) threats, and both NBC weapons and NBC accidents may bring fatal harm to our lives. The NBC protection tasks represented by decontamination have also expanded from military objectives to a diversified and wider scope. The main task of decontamination equipment is to implement timely and effective decontamination measures for infected combatants, weapons and equipment under NBC war conditions, so as to ensure survival, maintain combat and timely restore the combat effectiveness of troops, personnel and weapons and equipment; in the event of major nuclear and chemical accidents, nuclear, chemical and biological terrorist activities, and natural disasters, it can promptly eliminate pollution and safeguard the safety of public life. As a key part of safeguard and rescue under NBC conditions, decontamination equipment plays a vital role in preventing the spread of pollution, reducing the pollution rate and lowering the mortality rate. The operational capability and automation level of decontamination equipment play an important role in guaranteeing the safety of NBC protection in China, which is also one of the problems that need to be solved urgently.

Rapid and efficient decontamination of nuclear accident sites is an important measure to reduce radiation damage. Traditional decontamination equipment is mainly based on manual mode of operation, but the removal of radioactive contamination on the body surface of nuclear contaminated personnel is highly specialized and the process is strict, and must be mastered only after professional training. When doing on-site decontamination, machinery can be used instead of manual decontamination, through efficient decontamination operations can effectively reduce the dose of personnel exposure to radiation, reducing the possibility of contamination spread. Therefore, it is necessary to carry out research on multifunctional decontamination equipment.

### SUMMARY

In order to meet the urgent need for efficient decontamination of operators at a nuclear contamination site, a purpose of the present application is to provide an automatic cleaning device based on a decontamination robot and an automatic cleaning method. The cleaning device is the end execution device of the decontamination robot, which can realize rapid and effective physical cleaning of radioactive substances for contaminated operators at the nuclear contamination site, and quickly complete the decontamination task.

In order to realize the above purpose, the technical solution adopted in the present application is as follows:

An automatic cleaning device based on a decontamination robot, including a cleaning head, a cleaning seat, a protective housing and a cleaning module, wherein the cleaning head is fixedly mounted in the cleaning seat. The cleaning seat is rotationally connected with the cleaning module, and the cleaning module drives the cleaning seat and the cleaning head to realize up-and-down reciprocating motion. The protective housing passes through the cleaning head and the cleaning seat and is fixedly connected with the cleaning module, which can prevent harmful substances caused by cleaning from entering the inner cavity of the cleaning module and causing damage to the mechanism.

Further, the cleaning module includes a driving servo, an active bevel gear, a driven bevel gear, a fixing frame, a rail, a slider, a pinion gear, a driven bull gear, an oscillating rod, a connecting cross bar, a small connecting rod, a connecting bolt, a slewing connecting shaft, a connecting sleeve, a bull gear shaft, a bull gear bearing, a bull gear shaft sleeve, a pinion bearing, and an outer cover; the driving servo being fixedly mounted on the fixing frame, and the teeth shape on the output end of the driving servo is in interference fit with the matching teeth in inner bore of the active bevel gear, realizing the power transmission of the driving servo. One end of the driven bevel gear transmits power through gear meshing with the active bevel gear, and the other end passes through a pinion bearing to fit in interference fit with the pinion gear. The pinion bearing is nested in the fixing frame and resists against the shoulder of the driven bevel gear to realize the axial limitation of the driven bevel gear.

The cleaning head consists of multi-layer brushes; the end of the cleaning seat is provided with a mounting hole for rotary connection with the connecting cross bar of the cleaning module; the cleaning module drives the connecting cross bar through the movement of the oscillating rod, which drives the cleaning seat and cleaning head to realize the up-and-down reciprocating motion.

The pinion gear is in interference fit with the driven bevel gear, and meshes with the driven bull gear to realize power transmission through gear meshing. The bull gear shaft passes through the bull gear bearing, driven bull gear and bull gear shaft sleeve in turn, and is fixedly connected with the fixing frame through threads. The inner ring of the bull gear bearing and the bull gear shaft shoulder resist against with each other, and the outer ring is rotationally connected with the driven bull gear. The bull gear shaft sleeve is gap-fit with the bull gear shaft and both sides of which are rotationally connected with the driven bull gear and fixing frame respectively to realize axial positioning of the driven bull gear.

The rail is fixedly mounted in the guide groove of the fixing frame, and both ends of the rail are fixed by screws, and realizes limit position. There is a sliding fit between the slider and the rail, and the slider can slide between two limit screws of the rail.

One end of the oscillating rod is connected with the slider, and the other end is connected with the cleaning seat through a connecting cross bar. The slewing connecting shaft passes through the oscillating rod and connecting sleeve in turn, and is fixedly connected with the driven bull gear by means of threads. The center hole of the oscillating rod realizes circular motion with the driven bull gear, and one end of the oscillating rod moves linearly along the rail with the slider, and the other end of the oscillating rod drives the cleaning seat and the cleaning head to do up-and-down reciprocating motion through the connecting crossbar.

One end of the small connecting rod is rotatably connected with the fixing frame by screws, and the other end of which is connected with the cleaning seat by screws to realize the support of the cleaning seat, and the small connecting rod is installed symmetrically on both sides of the fixing frame respectively.

The outer cover is inserted from one end of the fixing frame, covering the whole cleaning module, and is fixedly connected with the fixing frame by screws.

An automatic cleaning method based on a decontamination robot is carried out using the above device in the following process: a drive servo in the cleaning module provides power to drive an active bevel gear matched and connected thereto to carry out rotational movement; the active bevel gear transmits power to a driven bevel gear through gear meshing; the driven bevel gear is rotationally connected with a fixing frame and is connected with a pinion gear through an interference fit, which transmits torque to the pinion gear, and there is a gear meshing between the pinion gear and the driven bull gear drives the driven bull gear to rotate around its rotary center; the slewing connecting shaft installed on the driven bull gear passes through the oscillating rod, driving the oscillating rod to move, and the other end of the oscillating rod is connected with the slider, so that the slider drives one end of the oscillating rod to do linear motion along the rail, driving the other end of the oscillating rod to do arc motion; the cleaning head and the cleaning seat are fixedly connected, and the middle of the cleaning seat is connected with the oscillating rod through the connecting cross bar, driving the cleaning head and one end of the oscillating rod to move simultaneously; at the same time, the end of the cleaning seat is connected with one end of the small connecting rod, and the other end of the small connecting rod is rotationally connected with the fixing frame, so as to form a linkage mechanism between the fixing frame, the small connecting rod, and the cleaning seat; the up-and-down reciprocating movement of the cleaning head can be realized through the power transmission of the gears and the deflection motion of the linkage mechanism to finally complete the automatic cleaning and decontaminating task to the radioactive substance for the decontamination robot.

The advantages and positive effects of the present application are:
1. The present application proposes an automatic cleaning device based on a decontamination robot, which has a wide range of applications and can be installed at the end of the decontamination robot to carry out efficient and fast decontamination and cleaning operations.
2. The present application can realize the up-and-down reciprocating motion of the cleaning tool through the connecting rod and slider mechanism, and the device structure is simple and easy to load and unload.
3. This application is based on the automatic cleaning device of the decontamination robot with small overall size, fast movement speed, and the cleaning speed and cleaning range can be adjusted according to the actual demand.

### BRIEF DESCRIPTION OF DRAWINGS

For a better understanding of the aforementioned embodiments of the present disclosure as well as additional embodiments thereof, reference should be made to the Description of Embodiments below, in conjunction with the following drawings in which like reference numerals refer to corresponding parts throughout the figures.

FIG. 1 shows a schematic diagram of the structure of the device of the present application;

FIG. 2 shows a schematic diagram of the internal structure of the device of the present application;

FIG. 3 shows one of the schematic diagrams of the structure of the cleaning module in the device of the present application;

FIG. 4 shows the other schematic diagram of the structures of the cleaning module in the device of the present application;

FIG. 5 is a schematic diagram of a sectional structure of the device of the present application;

Further, 1. a cleaning head; 2. a cleaning seat; 3. a protective housing; 4. a cleaning module; 5. a driving servo; 6. an active bevel gear; 7. a driven bevel gear; 8. a fixing frame; 9. a rail; 10. a slider; 11. a pinion gear; 12. a driven bull gear; 13. an oscillating rod; 14. a connecting cross bar; 15. a small connecting rod; 16. a connecting bolt; 17. a slewing connecting shaft; 18. a connecting sleeve; 19. a bull gear shaft; 20. a bull gear bearing; 21. a bull gear shaft sleeve; 22. a pinion bearing; and 23. an outer cover.

### DETAILED DESCRIPTION OF THE EMBODIMENTS

The present application is described in further detail below in conjunction with the accompanying drawings.

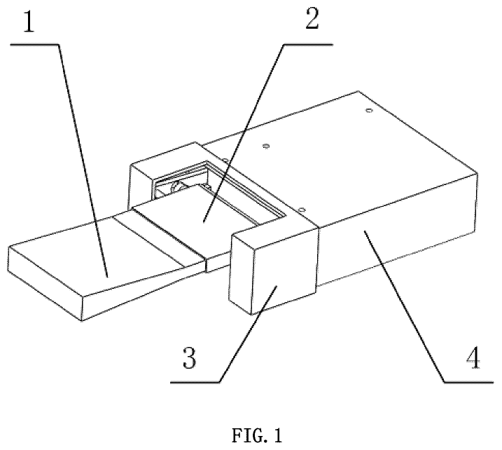

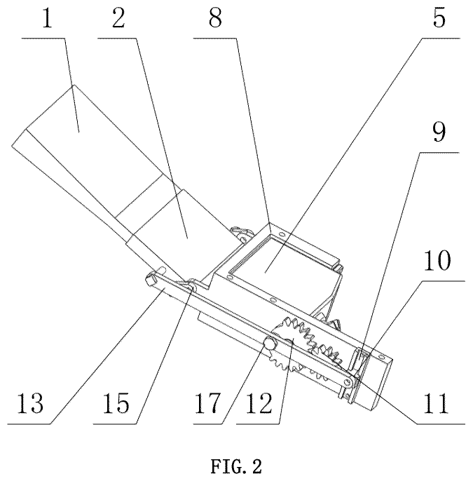

As shown in FIGS. 1 and 2, the present application provides an automatic cleaning device based on a decontamination robot, including a cleaning head 1, a cleaning seat 2, a protective housing 3, and a cleaning module 4, wherein the cleaning head 1 is consisting of a multi-layer brush, and the material of the multi-layer brush is natural plush (hog bristle, wool, etc.), a man-made fiber filament (plastic filament, abrasive nylon, etc.), and a metal filament (steel wire, copper wire, etc.), and one end of the cleaning head 1 is fixedly mounted in the cleaning seat 2. The end of the cleaning seat 2 is provided with a mounting hole for rotational connection with the connecting cross bar 14 of the cleaning module 4, and the cleaning module 4 drives the connecting cross bar 14 through the movement of the oscillating rod 13, which then drives the cleaning seat 2 and the cleaning head 1 to realize the up-and-down reciprocating movement. The protective housing 3 passes through the cleaning head 1 and the cleaning seat 2, and is fixedly connected with the cleaning module 4, which can prevent harmful substances caused by cleaning from entering the inner cavity of the cleaning module 4 and causing damage to the mechanism.

Optionally, the protective housing 3 is a C-shaped structure with a closed front end and open inner and rear ends, and the rear end of the protective casing 3 passes through the cleaning head 1 and the cleaning seat 2 in turn during installation and is connected with the open end (front end) of the outer cover of the cleaning module.

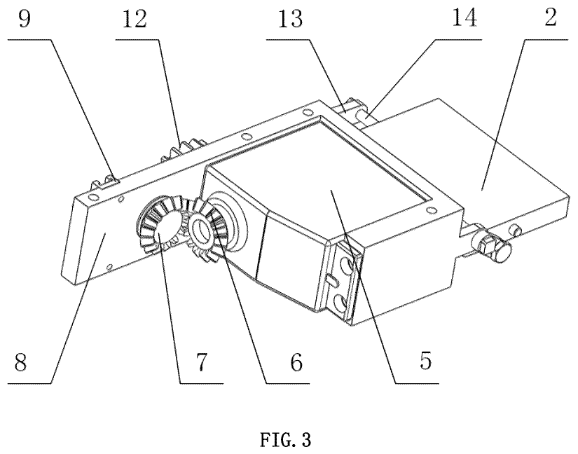

As shown in FIGS. 3, 4 and 5, the cleaning module 4 includes a driving servo 5, an active bevel gear 6, a driven bevel gear 7, a fixing frame 8, a rail 9, a slider 10, a pinion gear 11, a driven bull gear 12, an oscillating rod 13, a connecting cross bar 14, a small connecting rod 15, a connecting bolt 16, a slewing connecting shaft 17, a connecting sleeve 18, a bull gear shaft 19, a bull gear bearing 20, a bull gear shaft sleeve 21, a pinion bearing 22 and an outer cover 23, wherein the driving servo 5 is fixedly mounted on the inner side of the fixing frame 8, and the output end of the driving servo 5 is connected with the active bevel gear 6 (whose teeth shape on the output end of the driving servo is in interference fit with the matching teeth in inner bore of the active bevel gear) to realize the power transmission of the driving servo 5. One end of the driven bevel gear 7 (gear tooth end) meshes with the active bevel gear 6 to transmit power through gears, and the other end of the driven bevel gear 7 passes through the pinion bearing 22 to fit in interference with the pinion gear 11, thus driving the rotary motion of the pinion gear 11. The pinion bearing 22 is nested in the fixing frame 8 and resists the shoulder of the driven bevel gear 7 to realize the axial limitation of the driven bevel gear 7. The gear tooth end of the driven bevel gear is located on the inside of the fixing frame, while the pinion gear and the driven bull gear are located on the outside of the fixing frame.

Optionally, the active bevel gear 6 and driven bevel gear 7 have a transmission ratio of 1:1, and the pinion gear 11 and driven bull gear 12 have a transmission ratio of 3:5.

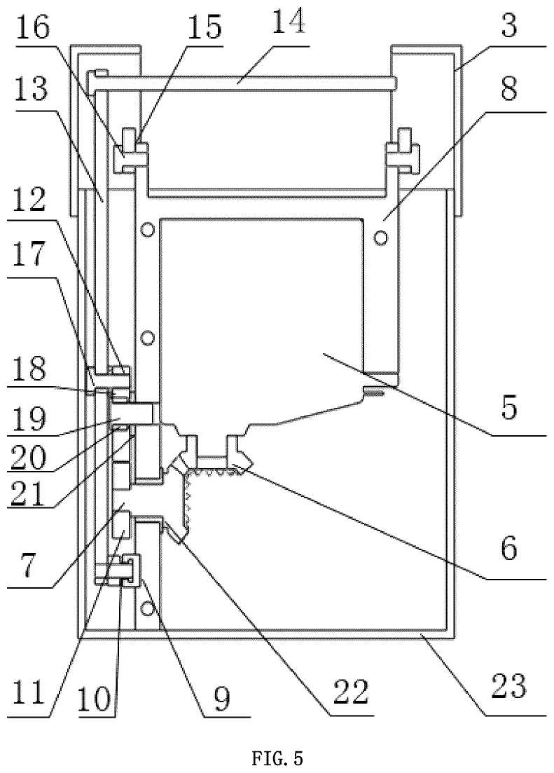

As shown in FIG. 5, the pinion gear 11 has an interference fit with the driven bevel gear 7 and meshes with the driven bull gear 12 through gears to realize power transmission. The bull gear shaft 19 passes through the bull gear bearing 20, the driven bull gear 12 and the bull gear shaft sleeve 21 in turn, and is fixedly connected with the fixing frame 8 by threads. The inner ring of the bull gear bearing 20 resists the shoulder of the bull gear shaft 19, and the outer ring realizes a rotary connection with the driven bull gear 12. The bull gear shaft sleeve 21 is gap-fit with the bull gear shaft 19 and both sides of which are rotationally connected with the driven bull gear 12 and fixing frame 8 respectively to realize axial positioning of the driven bull gear 12.

Optionally, the driven bull gear 12 adopts an incomplete tooth gear with a tooth arc of ±126°, and under the initial state, the pinion gear 11 meshes with the driven bull gear 12 at an angle of 0° in the center.

As shown in FIGS. 2 and 5, the rail 9 is fixedly mounted in the guide groove on the outer side of the fixing frame 8, and both ends of the rail are fixed by screws, to realize limit position. The slider 10 is slidingly fitted with the rail 9, and the slider 10 can slide between the two limiting screws of the rail 9. Optionally, the slider 10 is made of wear-resistant brass, and its moving range is ±20 mm, and when performing linear movement, lubricating oil needs to be sprayed between the slider 10 and the rail 9.

As shown in FIGS. 2 and 5, one end of the oscillating rod 13 is connected with the slider 10, and the other end is connected with the cleaning seat 2 through a connecting cross bar 14. The slewing connecting shaft 17 passes through the oscillating rod 13 and the connecting sleeve 18 in turn, and is fixedly connected with the driven bull gear 12 through threads. The center hole of the oscillating rod 13 (the hole through which the slewing connecting shaft 17 passes) moves in a circular motion with the driven bull gear 12, one end of which moves linearly along the rail 9 with the slider 10, and the other end of the oscillating rod 13 drives the cleaning seat 2 and the cleaning head 1 to do up-and-down reciprocating motion through the connecting cross bar 14. Optionally, the movement range of the cleaning head is ±80 mm, and the frequency of the up-and-down reciprocating movement is 30 times/min.

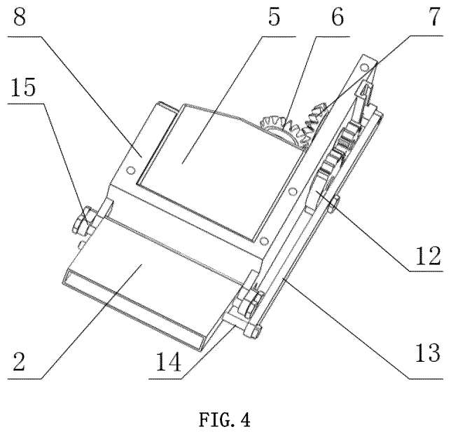

As shown in FIGS. 4 and 5, one end of the small connecting rod 15 of the present embodiment is rotatably connected with the fixing frame 8 by screws, and the other end of which is connected with the cleaning seat 2 by screws to realize the support of the cleaning seat 2, and the small connecting rod 15 is mounted symmetrically on both sides of the fixing frame 8 respectively.

As shown in FIG. 5, the outer cover 23 is inserted from one end of the fixing frame 8, covering the whole cleaning module, and is fixedly connected with the fixing frame 8 by screws.

The automatic cleaning device of the present application is fixed at the end of the decontamination robot.

The working principle of the present application is as follows:

When performing the decontamination cleaning operation, the driving servo 5 in the cleaning module 4 provides power, driving the active bevel gear 6 that matched and connected thereto to carry out rotational movement; the active bevel gear 6 transmits the power to the driven bevel gear 7 through gear meshing; the driven bevel gear 7 is rotationally connected with the fixing frame 8 and is connected with the pinion gear 11 through an interference fit, which transmits the torque to the pinion gear 11, and the pinion gear 11 is gear meshed with the driven bull gear 12, which drives the driven bull gear 12 to rotate around its rotary center. The slewing connecting shaft 17 mounted on the driven bull gear 12 passes through the oscillating rod 13, driving the oscillating rod 13 to move, and the other end of the oscillating rod 13 is connected with the slider 10, so that the slider 10 drives one end of the oscillating rod 13 to do linear motion along the rail 9, driving the other end of the oscillating rod 13 to do arc motion. The cleaning head 1 and the cleaning seat 2 are fixedly connected, and the middle of the cleaning seat 2 is connected with the oscillating rod 13 through the connecting cross bar 14, driving the cleaning seat 2 and one end of the oscillating rod 13 to move simultaneously. At the same time, the end of the cleaning seat 2 is connected with one end of the small connecting rod 15, and the other end of the small connecting rod 15 is rotationally connected with the fixing frame 8, so as to form a linkage mechanism between the fixing frame 8, the small connecting rod 15, and the cleaning seat 2. Through the power transmission of the gears and the deflection movement of the linkage mechanism, the up-and-down reciprocating movement of the cleaning head 1 can be realized, and the automatic cleaning and decontaminating task to the radioactive substance for the decontamination robot can be finally completed.

What is claimed is:

1. An automatic cleaning device, wherein the automatic cleaning device comprises a cleaning head, a cleaning seat, a protective housing and a cleaning module, wherein the cleaning head is fixedly mounted in the cleaning seat;
wherein the cleaning seat is rotationally connected with the cleaning module;
wherein the cleaning module drives the cleaning seat and the cleaning head to realize up-and-down reciprocating motion;
wherein the protective housing passes through the cleaning head and the cleaning seat and is fixedly connected with the cleaning module to prevent harmful substances caused by cleaning from entering an inner cavity of the cleaning module and causing damage to a mechanism.

2. The automatic cleaning device of claim 1,
wherein the cleaning module comprises a driving servo, an active bevel gear, a driven bevel gear, a fixing frame, a pinion gear, a driven bull gear, an oscillating rod, a connecting cross bar, a small connecting rod, a connecting bolt, a slewing connecting shaft, a connecting sleeve, a bull gear shaft, a bull gear bearing, a bull gear shaft sleeve, a pinion bearing and an outer cover,
wherein the driving servo is fixedly mounted on the fixing frame, and the teeth shape on the output end of the driving servo is in interference fit with the matching teeth in inner bore of the active bevel gear to realize the power transmission of the driving servo;
wherein one end of the driven bevel gear transmits power through gear meshing with the active bevel gear, and the other end passes through the pinion bearing to fit in interference with the pinion gear;
wherein the pinion bearing is nested in the fixing frame and resists against the shoulder of the driven bevel gear to realize the axial limitation of the driven bevel gear.

3. The automatic cleaning device of claim 2,
wherein the cleaning head comprises multi-layer brushes;
wherein an end of the cleaning seat is provided with a mounting hole for rotationally connecting with the connecting cross bar of the cleaning module;
wherein the cleaning module drives the connecting cross bar through the movement of the oscillating rod, which drives the cleaning seat and cleaning head to realize the up-and-down reciprocating motion.

4. The automatic cleaning device of claim 2,
wherein the pinion gear is in interference fit with the driven bevel gear and meshes with the driven bull gear to realize power transmission through gear meshing; the bull gear shaft passes through the bull gear bearing, the driven bull gear and the bull gear shaft sleeve in turn and is fixedly connected with the fixing frame through threads;
wherein an inner ring of the bull gear bearing resists the shoulder of the bull gear shaft, and an outer ring is rotationally connected with the driven bull gear;
wherein the bull gear shaft sleeve is gap-fit with the bull gear shaft and both sides of which are rotationally connected with the driven bull gear and fixing frame respectively to realize axial positioning of the driven bull gear.

5. The automatic cleaning device of claim 2,
wherein the cleaning module further comprises a rail and a slider, the rail is fixedly mounted in the guide groove of the fixing frame, and both ends of which are fixed by screws and realizes limit position; the slider is slidingly fitted with the rail and the slider can slide between two limit screws of the rail.

6. The automatic cleaning device of claim 5,
wherein one end of the oscillating rod is connected with the slider, and the other end is connected with the cleaning seat through the connecting cross bar; the slewing connecting shaft passes through the oscillating rod and connecting sleeve in turn and is fixedly connected with the driven bull gear through threads.

7. The automatic cleaning device of claim 6,
wherein a center hole of the oscillating rod moves in a circular motion with the driven bull gear, one end of which moves linearly along the rail with the slider, and the other end of the oscillating rod drives the cleaning seat and the cleaning head to do up-and-down reciprocating motion through the connecting cross bar.

8. The automatic cleaning device of claim 2,
wherein one end of the small connecting rod is rotatably connected with the fixing frame by screws, and the other end is connected with the cleaning seat by screws, so as to realize the support of the cleaning seat, and the small connecting rod is mounted symmetrically on both sides of the fixing frame respectively.

9. The automatic cleaning device of claim 2,
wherein the outer cover is inserted from one end of the fixing frame to cover the whole cleaning module and is fixedly connected with the fixing frame by screws.

10. An Automatic cleaning method employing the automatic cleaning device described in claim 1, wherein the cleaning method is as follows:
the driving servo in the cleaning module provides power to drive the active bevel gear that matched and connected thereto to carry out rotational movement;
the active bevel gear transmits power to the driven bevel gear through gear meshing, the driven bevel gear is rotationally connected with the fixing frame, and is connected with the pinion gear through the interference fit, which transmits the torque to the pinion gear;
the pinion gear is gear meshed with the driven bull gear, which drives the driven bull gear to rotate around its rotary center;
the slewing connecting shaft mounted on the driven bull gear passes through the oscillating rod, driving the oscillating rod to move, and the other end of the oscillating rod is connected with the slider, so that the slider drives one end of the oscillating rod to do linear motion along the rail, driving the other end of the oscillating rod to do arc motion;
the cleaning head and the cleaning seat are fixedly connected, and the middle of the cleaning seat is connected with the oscillating rod through the connecting cross bar, driving the cleaning seat and one end of the oscillating rod to move simultaneously;
wherein, at the same time, the end of the cleaning seat is connected with one end of the small connecting rod, and the other end of the small connecting rod is rotationally connected with the fixing frame, so as to form a linkage mechanism between the fixing frame, the small connecting rod, and the cleaning seat;
wherein, through the power transmission of the gears and deflection movement of the linkage mechanism, the up-and-down reciprocating movement of the cleaning head can be realized.
